(19) United States
(12) Patent Application Publication
(10) Pub. No.: US 2023/0300917 A1
(43) Pub. Date: Sep. 21, 2023

(54) TERMINAL

(71) Applicant: NTT DOCOMO, INC., Tokyo (JP)

(72) Inventor: Tianyang Min, Tokyo (JP)

(73) Assignee: NTT DOCOMO, INC., Tokyo (JP)

(21) Appl. No.: 18/040,918

(22) PCT Filed: Aug. 13, 2020
(86) PCT No.: PCT/JP2020/030788

§ 371 Date: Feb. 7, 2023

(51) Int. Cl. H04W 76/14; H04W 56/00; H04W 76/23

(52) U.S. Cl. CPC H04W 76/14; H04W 56/005; H04W 76/23; H04W 88/06

(57) ABSTRACT

A terminal includes a control unit that performs processing related to a first network and a second network; and a transmission unit that transmits a message used in the first network and including time information of the second network, when two or more terminals, to which two or more stations belongs to the second network respectively connected, are located in a neighborhood.

### TECHNICAL FIELD

This disclosure relates to terminals that perform radio communications, and in particular, to terminals that perform processing relating to the synchronization of TSNs.

### BACKGROUND ART

The 3rd Generation Partnership Project (3GPP) specifies 5th generation mobile communication system (5G, also called New Radio (NR) or Next Generation (NG), further, a succeeding system called Beyond 5G, 5G Evolution or 6G is being specified.

In 3GPP Release 16, NR will support the Industrial Internet of Things (IIoT) (see Non-Patent Literature 1). To achieve IIoT support, NR is being considered to enable synchronization of TSN end stations belonging to the Time Sensitive Network (TSN).

### CITATION LIST

### Non-Patent Literature

Non-Patent Literature 1: 3GPP TR23.734 V16.2.0, 3rd Generation Partnership Project; Technical Specification Group Services and System Aspects; Study on enhancement of 5G System (5GS) for vertical and Local Area Network (LAN) services (Release 16), 3 GPP, June 2019

### SUMMARY OF INVENTION

However, the technology described above only assumes a case where the TSN end station connected to the User Plane Function (UPF) provided in the core network of the NR is a GM (grandmaster) and delivers the TSN time from the UPF. Therefore, further consideration is required for synchronization between TSN end stations connected to two or more UEs.

In addition, although propagation delay compensation has been discussed in the IIoT in the aforementioned technologies, its details have not been discussed, and the implementation of propagation delay compensation is also called for further investigation.

Therefore, the following disclosure has been made in view of this situation, and the purpose of the disclosure is to provide a terminal capable of appropriately executing processing related to TSN synchronization.

One aspect of the present disclosure is a terminal comprising: a control unit that performs processing related to a first network and a second network; and a transmission unit that transmits a message used in the first network and including time information of the second network, when two or more terminals, to which two or more stations belongs to the second network respectively connected, are located in a neighborhood.

### BRIEF DESCRIPTION OF DRAWINGS

FIG. 1 is the overall schematic configuration of the control system 10.

FIG. 2 is a functional block diagram of the UE 200.

FIG. 3 shows an example of operation 1 of the control system 10.

FIG. 4 is a diagram showing operation example 2 of the control system 10.

FIG. 5 is a diagram showing an example of the operation of the control system 10 according to Modified Example 1.

FIG. 6 is a diagram showing an example of the TA Command according to Modified Example 2.

FIG. 7 is a diagram showing an example of operation of the control system 10 according to Modified Example 3.

FIG. 8 is a diagram showing an example of the operation of the control system 10 according to Modified Example 4.

FIG. 9 is a diagram showing an example of the operation of the control system 10 according to Modified Example 5.

FIG. 10 is a diagram showing an example of the hardware configuration of the UE 200.

### MODES FOR CARRYING OUT THE INVENTION

Exemplary embodiments of the present invention are explained below with reference to the accompanying drawings. Note that, the same or similar reference numerals have been attached to the same functions and configurations, and the description thereof is appropriately omitted.

(1) Overall Schematic Configuration of Control System

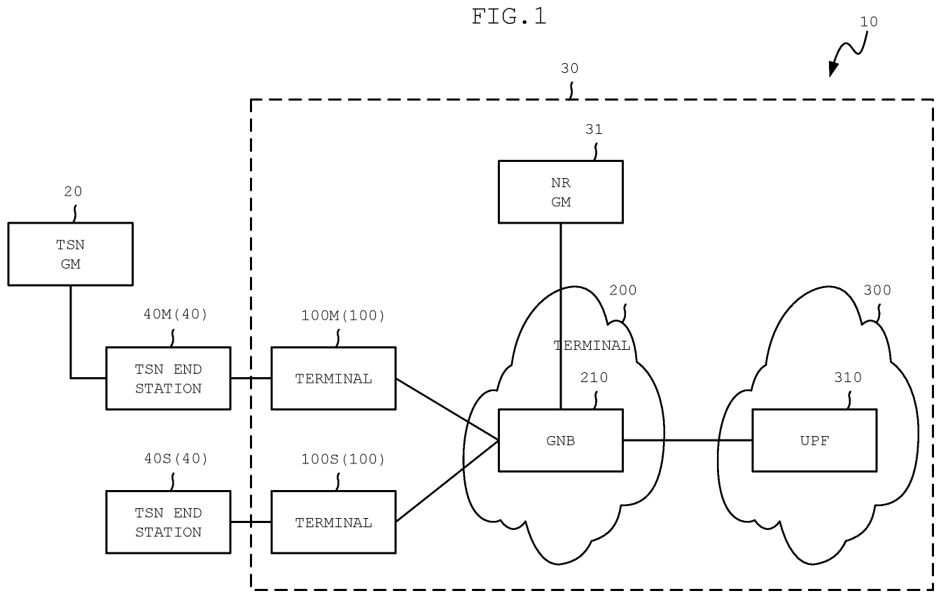

FIG. 1 is the overall schematic configuration of the control system 10 according to the embodiment.

The control system 10 includes a TSN grandmaster (TSN GM) 20, an NR system 30 and a TSN end station 40. In FIG. 1, TSN end station 40M and TSN end station 40S are illustrated as TSN end stations 40. The TSN End Station 40M is connected to the TSN GM 20 and is a device that acts as a source of time synchronization, at least in a Time Sensitive Network (TSN). TSN end station 40S is not connected to TSN GM 20 and performs time synchronization with TSN end station 40M.

The TSN GM 20 generates a clock that is the timing of the TSN's operation. Hereafter, the time generated based on the clock oscillated by the TSN GM 20 is called TSN time. The TSN time is the reference time applied within the TSN.

TSN time is used to achieve highly accurate time synchronization between TSN end station 40M and TSN end station 40S. This requires that TSN end station 40M and TSN end station 40S synchronize to TSN time.

In an embodiment, the TSN is an example of a second network. The TSN may be referred to as a specific network or other network other than a radio network. In such cases, the TSN time may be referred to as the time used in a particular network or in other networks other than radio networks. A TSN may be referred to as a network in which all nodes in the network share the same time. The TSN may be referred to as a network that supports deterministic communication or as a network that supports isochronous communication.

The NR system 30 includes an NR grandmaster (NR GM) 31, a terminal 100, a Next Generation-Radio Access Network 200 (Below: NG-RAN 200), and a core network 300. The terminal is also referred to as a user equipment (UE). In FIG. 1, terminals 100M and 100S are illustrated as terminals 100. The terminal 100M is connected to TSN end station 40M and the terminal 100S is connected to TSN end station 40S.

The NR GM 31 oscillates a clock which is the operating timing of the NR system 30. Hereafter, the time generated based on the clock oscillated by the NR GM 31 is called the NR time. The NR time is the reference time applied within the NR system 30.

The NR time is used to achieve highly accurate time synchronization within the NR system 30. Therefore, the terminal 100, the NG-RAN 200 and the core network 300 need to be synchronized with the NR time.

The terminal 100 performs radio communication according to NR between terminal 100 and NG-RAN 200 and core network 300. The terminal 100 is connected to TSN GM 20 and NR GM 31.

The NG-RAN 200 includes multiple NG-RAN nodes, specifically, a radio base station (hereafter referred to as gNB) 210, and is connected to a core network (5GC) 300 in accordance with NR. The NG-RAN 200 and the core network 300 may be simply expressed as an NR network. The terminal 100 is connected to the NR network.

In an embodiment, the NR network is an example of a first network. The NR network may be referred to as a specific network or as a radio network. In such cases, the NR time may be referred to as the time used in a particular network or the time used in a radio network.

By controlling radio signals transmitted from multiple antenna elements, the terminals 100 and the gNB 210 can support Massive MIMO for generating more directional beams, carrier aggregation (CA) using multiple component carriers (CCs), and dual connectivity (DC) for transmitting CCs simultaneously between multiple NG-RAN nodes and terminals. CC is also known as carrier.

The core network 300 includes a User Plane Function (UPF) 310. The UPF 310 provides specialized functionality for user plane processing. The UPF 310 may receive the TSN time from the terminal 100M via the gNB 210 and transmit the received TSN time to the terminal 100S.

The TSN end station 40 is an example of a station belonging to the second network (TSN). For example, the TSN end station 40 is a machine installed in a production plant. The TSN end station 40M updates the TSN time held by the TSN end station 40M from time to time based on the TSN time obtained from the TSN GM 20. The TSN end station 40S occasionally updates the TSN time held by the TSN end station 40S based on the TSN time obtained from the TSN end station 40M.

(2) Function Block Configuration of Terminal 100

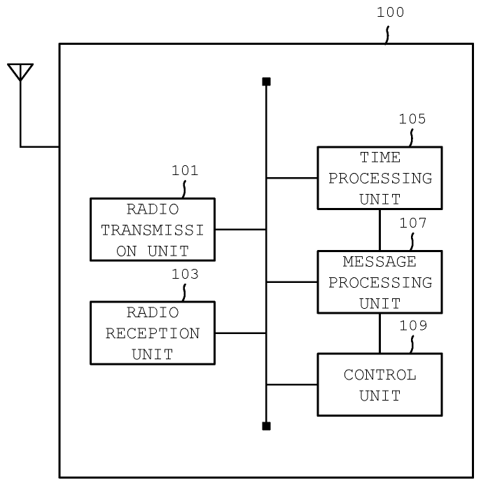

FIG. 2 is a functional block diagram of the terminal 100. The aforementioned terminals 100M and 100S have similar configurations, and will be referred to simply as terminal 100 in the following. The hardware configuration of the terminal 100 will be described later. As shown in FIG. 2, the terminal 100 comprises a radio transmission unit 101, a radio reception unit 103, a time processing unit 105, a message processing unit 107, and a control unit 109.

The radio transmission unit 101 transmits an uplink signal (UL signal) in accordance with NR. The radio reception unit 103 receives a downlink signal (DL signal) in accordance with NR. Specifically, the radio transmission unit 101 and the radio reception unit 103 perform radio communication between the terminal 100 and gNB 210 via physical uplink control channel (PUCCH), physical uplink shared channel (PUSCH), physical downlink control channel (PDCCH), physical downlink shared channel (PDSCH), physical random access channel (PRACH), etc.

For example, the radio transmission unit 101 transmits a random-access preamble (Msg.1) to the gNB 210 in a random-access (RA) procedure. The radio transmission unit 101 transmits a reference signal, such as a sounding reference signal (SRS) and a demodulation reference signal (DMRS), to the gNB 210. The radio transmission unit 101 transmits the measurement signal of the terminal side to the gNB 210.

For example, the radio reception unit 103 receives a random access response (Msg.2) from the gNB 210 in an RA procedure. The random access response is a response signal to the random access preamble described above and includes a timing advance (TA) command. The TA command includes a TA value used to adjust the transmission timing of the terminal 100. The radio reception unit 103 receives a control message (TA MAC CE) at the medium access control (MAC) layer from the gNB 210. TA MAC CE is a response signal to the reference signal described above and includes TA commands used to adjust the transmission timing of the terminal 100.

The time processing unit 105 manages TSN times. When the terminal 100 is the terminal 100M, the time processing unit 105 manages the TSN time acquired from the TSN GM 20 via the TSN end station 40M. When the terminal 100 is the terminal 100S, the time processing unit 105 manages the TSN time acquired from the terminal 100M via the NR system 30. When the terminal 100 is a terminal 100S, the time processing unit 105 notifies the TSN end station 40S of the TSN time.

The message processing unit 107 processes various messages (RRC messages, MAC CE messages, Side Link messages, etc.). In the embodiment, when the terminal 100 is a terminal 100M, the message processing unit 107 constitutes an transmission unit that transmits a message used in the first network (NR network) and including time information (TSN time) of the second network (TSN). Specifically, as shown in FIG. 1, when two or more terminals 100 connected to each of two or more TSN end stations 40 belonging to the TSN are located in the neighborhood, the message processing unit 107 may send a message used in the NR network and including the TSN time. The state in which two or more terminals 100 are located nearby may include a state in which two or more terminals 100 are located within the coverage area of the same NG-RAN 200 (connected or idle). A state in which two or more terminals 100 are located nearby may include a state in which two or more terminals 100 are connected by a Side Link.

Here, the message including the TSN time may be an RRC message used in the NR network. That is, the message processing unit 107 may transmit an RRC message including the TSN time to the NR network (gNB 210). The RRC message may be one or more messages selected from RRC Setup Request (Msg.3), RRC Setup Complete (Msg.5), RRC Reconfiguration Complete, RRC Reestablishment Request, RRC Reestablishment Complete, RRC Resume Request RRC Resume Complete, UE Assistance Information, Dedicated SI Request, and UE Information Response.

The message including the TSN time may be a side link message used between terminals 100 (For example, the aforementioned terminal 100M and terminal 100S) that can connect to the NR network. That is, the message processing unit 107 may send a Side Link message including the TSN time to the terminal 100S. The Side Link message may be one or more messages selected from Master Information Block Side Link, Measurement Report Side Link, and RRC Reconfiguration Side Link. In such a case, the terminal 100M may be a terminal (In-coverage UE) that exists within the coverage of the gNB 210. The terminal 100S may be a terminal (In-coverage UE) that exists within the coverage of the gNB 210 or a terminal (Out-of-coverage UE) that exists outside the coverage of the gNB 210. If the terminal 100S is an out-of-coverage UE, the Side Link message including the TSN time may be a message (For example, Master Information Block Side Link) sent using a predetermined resource.

The control unit 109 controls each functional block that makes up the terminal 100. The control unit 109 performs processing concerning the first network (NR network) and the second network (TSN). For example, processing on NR networks includes processing on radio signals, processing on RRC messages, processing on MAC CE messages, processing on Side Link messages, etc. Processing on the TSN includes processing to manage TSN times, synchronization processing using TSN times, etc.

As described above, the embodiment focuses on a case where the terminal 100M connected to the TSN end station 40M and the terminal 100S connected to the TSN end station 40S can be connected to the same NG-RAN 200 (or gNB 210). In other words, terminal 100M looks at a case where it shares TSN time with terminal 100S, which is located in the vicinity of terminal 100M. In such a case, the terminal 100M transmits the TSN time to the gNB 210 or the terminal 100S using a message used in the NR network.

(3) Operation of the Control System

Next, the operation of the control system 10 is described. Herein, the operation of sharing TSN time between terminal 100M and terminal 100S will be mainly described.

### (3.1) Operation Example 1

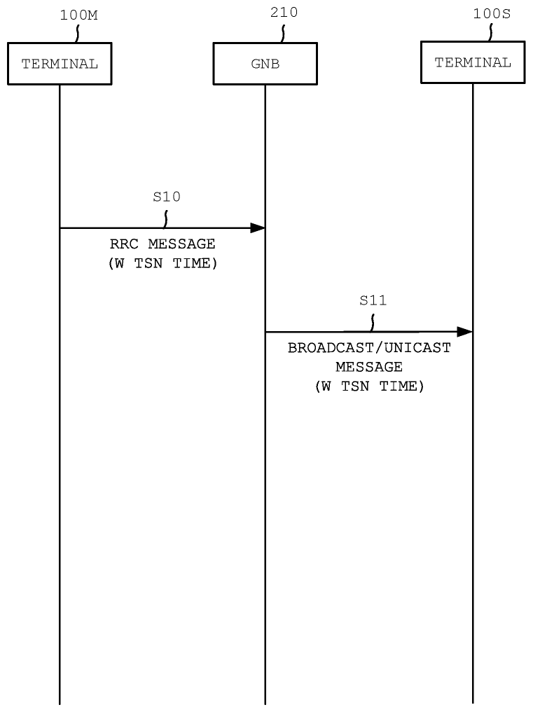

As shown in FIG. 3, in step S10, the terminal 100M transmits an RRC message including the TSN time to the gNB 210. Terminal 100M obtains TSN time from TSN GM 20 via TSN end station 40M.

As mentioned above, the RRC message may be one or more messages selected from among RRC Setup Request (Msg.3), RRC Setup Complete (Msg.5), RRC Reconfiguration Complete, RRC Reestablishment Request, RRC Reestablishment Complete, RRC Resume Request RRC Resume Complete, UE Assistance Information, Dedicated SI Request, and UE Information Response.

In step S11, the gNB 210 sends a message including the TSN time to the terminal 100S. The message may be a broadcast message or a Unicast message. The broadcast message may be a Master Information Block (MIB) or a System Information Block (SIB). Unicast messages may be RRC messages or MAC CE messages. The terminal 100S may be an idle UE or a connected UE. The terminal 100S may notify the TSN end station 40S of the TSN time.

### (3.2) Example 2

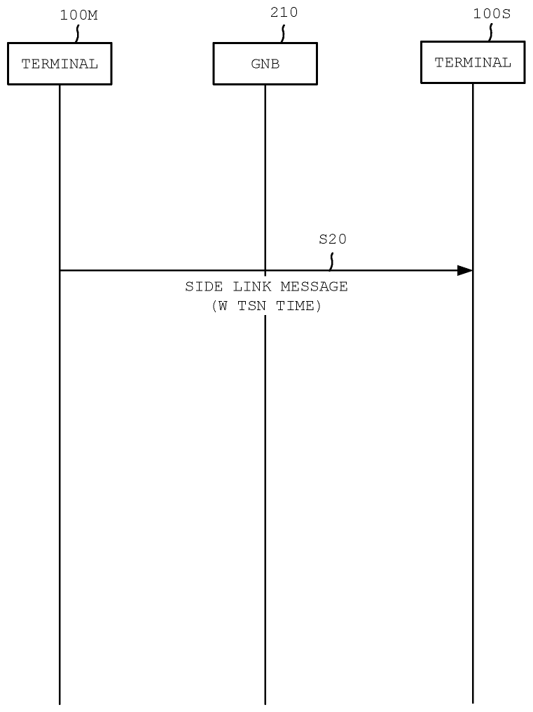

As shown in FIG. 4, in step S20, the terminal 100M sends a Side Link message including the TSN time to the terminal 100S. Terminal 100M obtains TSN time from TSN GM 20 via TSN end station 40M. The terminal 100S may be an idle UE or a connected UE. The terminal 100S may be an In-coverage UE or an Out-of-coverage UE. The terminal 100S may notify the TSN end station 40S of the TSN time.

As mentioned above, the Side Link message may be one or more messages selected from among Master Information Block Side Link, Measurement Report Side Link, and RRC Reconfiguration Side Link.

(4) Operational Effects

In an embodiment, the terminal 100M transmits a message that is used in an NR network and includes the TSN time of the TSN. With such a configuration, the TSN time can be shared with the terminal 100S connected to the NR network, that is, the terminal 100S located in the vicinity of the terminal 100M. In other words, the TSN time of TSN end station 40M connected to the TSN GM 20 can be shared with the TSN end station 40S.

In an embodiment, the gNB 210 sends a message including the TSN time to the terminal 100S. Alternatively, the terminal 100M sends a message including the TSN time to the terminal 100S. With such a configuration, the sharing of TSN time is completed within the NG-RAN 200 without using the core network 300 (UPF 310), so that quick synchronization can be achieved.

In an embodiment, the UPF 310 may receive the TSN time from the terminal 100M via the gNB 210 and transmit the received TSN time to the terminal 100S. In other words, the TSN time may be included in the gPTP (generalized Precision Time Protocol) message specified in the IEEE (Institute of Electrical and Electronics Engineers) 802.1 AS and sent to the terminal 100S in user-plane processing. With such a configuration, TSN time sharing can be realized without changing the NG-RAN 200 specifications (For example, RRC message specifications).

### Modified Example 1

A Modified Example 1 of the embodiment will be described below. The differences with respect to the embodiment are mainly described below.

In the embodiment, a case is described in which a TSN end station 40M connected to a TSN GM 20 is connected to a UE 100M. However, in Modified Example 1, the TSN end station 40M connected to the TSN GM 20 may be connected to the UPF 310 without being connected to the UE 100M. In such a case, the TSN time may be notified from the UPF 310 to the TSN end station 40S via the terminal 100S. Modification example 1 describes compensation of propagation delay between terminal 100 and gNB 210. It should be noted that compensation for propagation delay contributes to the synchronization of TSN times.

Specifically, the terminal 100 receives timing information (TA command) used for timing adjustment of the uplink signal. The radio reception unit 103 described above may constitute a reception unit that receives TA commands. The terminal 100 performs propagation delay compensation based on the TA command when a predetermined condition is satisfied. The aforementioned control unit 109 may constitute a control unit that performs propagation delay compensation.

Here, propagation delay compensation may include processing to change the TSN time based on the TA value (For example, N_{TA}) included in the TA command. For example, propagation delay compensation may include processing to add the propagation delay time to the TSN time. The propagation delay time may be represented by N_{TA}*Tc/2. N_{TA} is the TA between the downlink and the uplink, and Tc is the basic time unit for NR. The propagation delay time may not include N_{TA, offset}. N_{TA, offset} is a fixed offset value (see 3 GPP T538.211 V 16.2.0 section 4.3.1).

Propagation delay compensation may include processing to change the TSN time based on the UE RX-TX time difference (see 3 GPP T538.215 V 16.2.0 section 5.1.30). For example, propagation delay compensation may include processing to add the propagation delay time to the TSN time. The propagation delay time may be represented by {T_{UE-RX}−T_{UE-TX}}/2. The T_{UE-RX} is when the UE receives the downlink subframe #i, and the T_{UE-TX} is when the UE transmits the uplink subframe #j that is closest in time to the downlink subframe #i.

Propagation delay compensation may include processing to change the TSN time based on the gNB RX-TX time difference (see 3 GPP TS38.215 V 16.2.0 section 5.2.3). For example, propagation delay compensation may include processing to add the propagation delay time to the TSN time. Propagation delay time may be represented by {T_{gNB-RX}−T_{gNB-TX}}/2. I_{gNB-RX} is the timing at which gNB receives the uplink subframe #i, and T_{gNB-TX} is the timing at which gNB transmits the downlink subframe #j that is closest in time to the uplink subframe #i.

In Modified Example 1, the predetermined condition includes a condition in which the propagation delay time (For example, N_{TA}×Tc/2) specified by the timing information (TA command) is greater than the predetermined threshold.

The predetermined threshold may be referred to as TA value threshold. The predetermined threshold may be defined according to the size of the coverage area (which may be referred to as the service area) of the gNB 210. The predetermined threshold may be defined according to the synchronization specifications required for the NR network. The predetermined threshold may be set by a message sent from the gNB 210. For example, a predetermined threshold may be set by a broadcast message (For example, SIBS) or by an RRC message (For example, DLInformationTransfer).

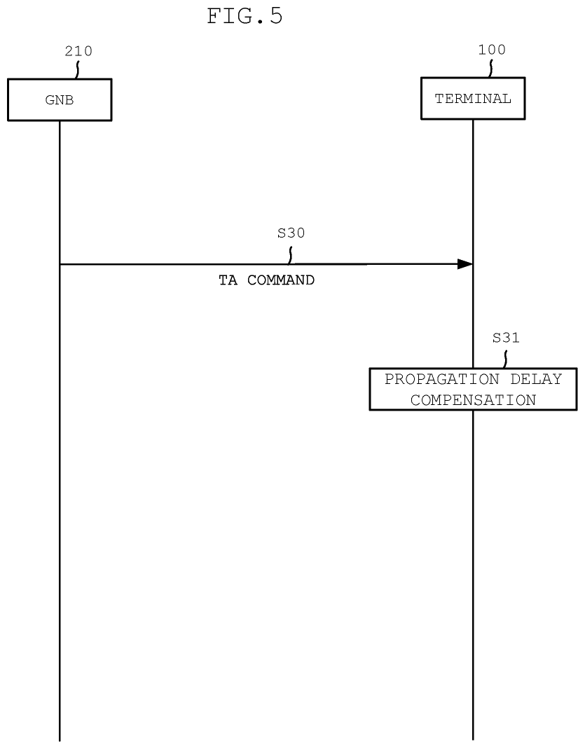

Specifically, as shown in FIG. 5, in step S30, the terminal 100 receives the TA command from the gNB 200. As mentioned above, the TA command may be included in a random access response (Msg.2) or in a control message (TA MAC CE) at the MAC layer.

In step S31, the terminal 100 determines whether the propagation delay time is greater than a predetermined threshold. We will continue to explain the case where the propagation delay time is greater than a predetermined threshold. Therefore, the terminal 100 performs propagation delay compensation based on the TA command because a predetermined condition is satisfied where the propagation delay time is greater than a predetermined threshold.

In Modified Example 1, the terminal 100 performs propagation delay compensation based on the TA command when the propagation delay time is greater than a predetermined threshold. With such a configuration, since the execution of propagation delay compensation is omitted when the propagation delay time is small, the processing load of the terminal 100 is smaller than when the propagation delay compensation is always executed. In addition, when the propagation delay time is small, it is considered that the effectiveness of the propagation delay compensation is poor, so that the propagation delay compensation can be implemented under appropriate circumstances. Furthermore, propagation delay compensation can be realized while suppressing the introduction of additional signaling.

### Modified Example 2

A Modified Example 2 of the embodiment will be described below. The differences from Modification 1 are mainly described below.

In Modified Example 1, the terminal 100 autonomously performs propagation delay compensation when the condition that the propagation delay time is greater than a predetermined threshold is satisfied. On the other hand, in Modified Example 2, the terminal 100 performs propagation delay compensation when the condition in which there is an instruction for performing propagation delay compensation is satisfied, and the terminal 100 performs propagation delay compensation. That is, the prescribed condition may include a condition in which there are instructions for performing propagation delay compensation. The predetermined conditions may include, in addition to such conditions, conditions in which the propagation delay time is greater than the predetermined threshold.

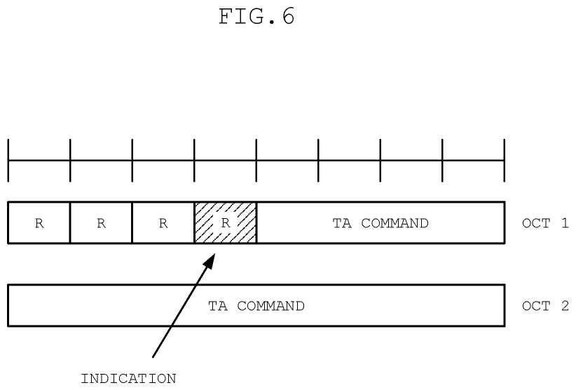

Instructions for performing propagation delay compensation may be set by information elements included in the TA command. For example, as shown in FIG. 6, the reserved bit (R) included in the TA command may be used as an indication for performing propagation delay compensation. For example, an Indication set to “1” means to instruct the execution of propagation delay compensation, and an Indication set to “0” may mean not to instruct the execution of propagation delay compensation.

Instructions for performing propagation delay compensation may be set by messages sent from the gNB 210. For example, instructions for performing propagation delay compensation may be set by broadcast messages (For example, SIBS) or by RRC messages (For example, DLInformationTransfer).

In Modified Example 2, the terminal 100 performs propagation delay compensation based on the TA command when instructions for performing propagation delay compensation exist. With such a configuration, the propagation delay compensation can be flexibly executed by the terminal 100 under the initiative of the NG-RAN 200, and for example, the execution of duplicate propagation delay compensation by the NG-RAN 200 and the terminal 100 can be suppressed.

The instructions for executing propagation delay compensation may be issued under the initiative of NG-RAN 200, may use explicit information elements, or may use implicit information elements.

### Modified Example 3

A Modified Example 3 of the embodiment will be described below. The differences between Modified Example 1 and Modified Example 2 are mainly explained below.

In change example 1, the terminal 100 autonomously performs propagation delay compensation, and in change example 2, the terminal 100 performs propagation delay compensation based on the instruction of gNB 210 (NG-RAN 200). In contrast, in Modified Example 3, gNB 210 (NG-RAN 200) sets whether the terminal 100 performs propagation delay compensation autonomously or the terminal 100 performs propagation delay compensation based on the instruction of gNB 210.

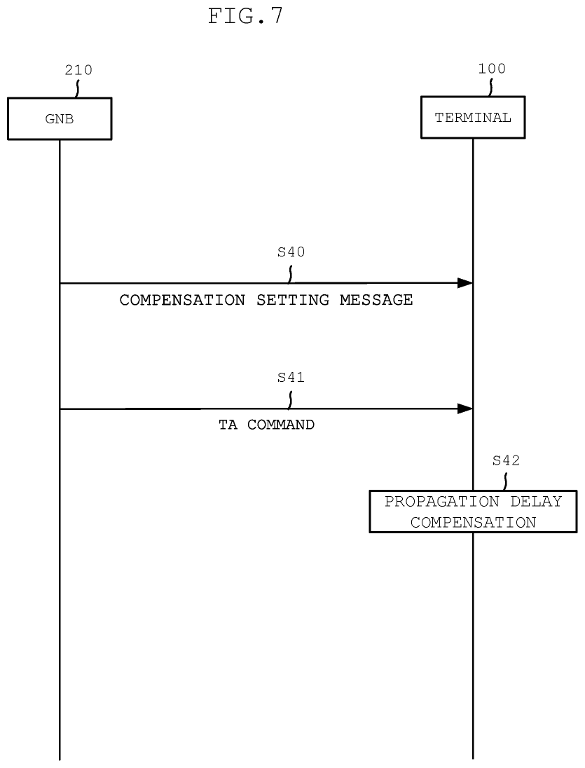

Specifically, as shown in FIG. 7, in step S40, the terminal 100 receives compensation setting message from the gNB 210. The compensation setting message may include an information element that sets the autonomous execution of propagation delay compensation, and the compensation setting message may include an information element that sets the execution of propagation delay compensation as directed by gNB 210. The compensation setting message may include both of these information elements. The compensation setting message may be an RRC message. The information elements described above may be included in the Other Config IE.

In step S41, the terminal 100 receives the TA command from the gNB 200. As mentioned above, the TA command may be included in a random access response (Msg.2) or in a control message (TA MAC CE) at the MAC layer.

In step S42, the terminal 100 performs propagation delay compensation based on the TA command when autonomous execution of propagation delay compensation is set and the propagation delay time is greater than a predetermined threshold. In other words, the terminal 100 does not perform propagation delay compensation if autonomous execution of propagation delay compensation is not set, even if the propagation delay time is greater than a predetermined threshold.

Alternatively, the terminal 100 executes propagation delay compensation based on the TA command when execution of propagation delay compensation by the instruction of the gNB 210 is set and an instruction for execution of propagation delay compensation exists. In other words, the terminal 100 does not perform the propagation delay compensation if the execution of the propagation delay compensation by the instruction of the gNB 210 is not set even if the instruction regarding the execution of the propagation delay compensation exists.

### Modified Example 4

A Modified Example 4 of the embodiment will be described below. The differences between examples 1 through 3 are mainly described below.

In Modified Example 1 to Modified Example 3, the terminal 100 performs propagation delay compensation. In contrast, in Modified Example 4, gNB 210 (NG-RAN 200) performs propagation delay compensation. In such a case, the gNB 210 sends to the terminal 100 a message (Notification message below) including an information element indicating that propagation delay compensation is not to be performed or an information element indicating that propagation delay compensation has been performed. When the terminal 100 receives such a notification message, it need not perform propagation delay compensation. In the TA command shown in FIG. 6, the TA command including Indication with “0” set may be considered as such a notification message.

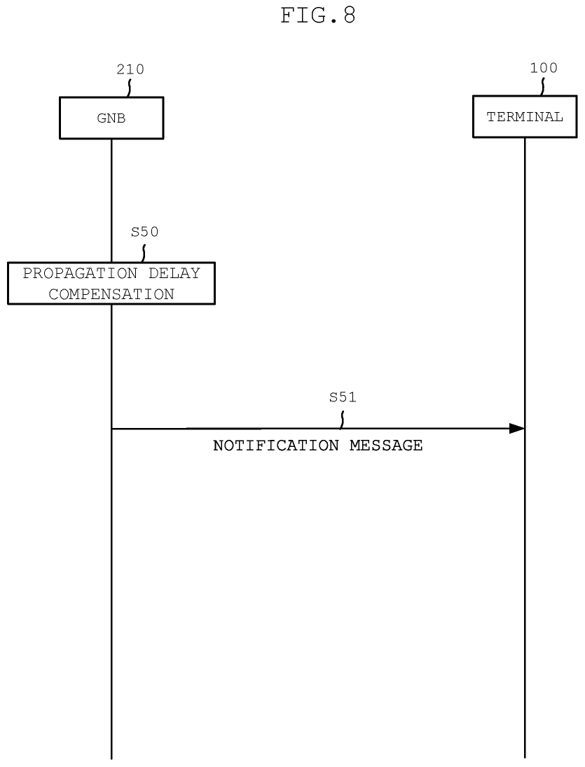

Specifically, as shown in FIG. 8, in step S50, the gNB 210 performs propagation delay compensation. Propagation delay compensation may include processing to change the TSN time based on the TA value (For example, N_{TA}), as in Modified Example 1, etc. For example, propagation delay compensation may include processing to add the propagation delay time to the TSN time. The propagation delay time may be represented by N_{TA}*Tc/2.

In step S51, the terminal 100 receives a notification message from the gNB 210. The notification message may include an information element indicating that propagation delay compensation is not to be performed, or it may include an information element indicating that propagation delay compensation has been performed.

### Modified Example 5

A Modified Example 5 of the embodiment will be described below. The differences between Modified Examples 1 through 4 are mainly described below.

In Modified Example 5, an information element indicating whether or not propagation delay compensation is to be performed is transmitted with the TSN time. For example, the terminal 100M may send to the gNB 210 an information element indicating whether or not to cause the gNB 210 to perform propagation delay compensation together with the TSN time. If propagation delay compensation is being performed by the terminal 100M, the terminal 100M may transmit an information element indicating that propagation delay compensation is not to be performed by the gNB 210 or an information element indicating that radio delay compensation has been performed along with the TSN time. Similarly, the gNB 210 may send to the terminal 100S an information element indicating whether or not to cause the terminal 100S to perform propagation delay compensation together with the TSN time. If propagation delay compensation is being performed at the terminal 100M or gNB 210, the terminal 100M may transmit an information element indicating that propagation delay compensation is not to be performed by the terminal 100S or an information element indicating that radio delay compensation has been performed along with the TSN time.

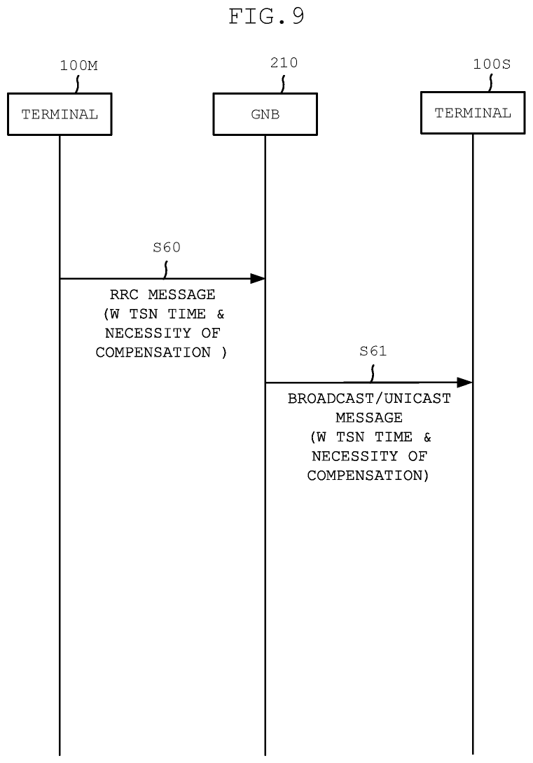

Specifically, as shown in FIG. 9, in step S60, the terminal 100M transmits an RRC message including the TSN time to the gNB 210. The RRC message includes an information element (In FIG. 9, the need for compensation) that indicates whether or not the gNB 210 should perform propagation delay compensation.

In step S61, the gNB 210 sends a message including the TSN time to the terminal 100S. The message includes an information element (In FIG. 9, the need for compensation) that indicates whether or not to cause the terminal 100S to perform propagation delay compensation.

### Other Embodiments

Although the above description of the embodiment is not limited to the description of the embodiment, it is obvious to those skilled in the art that various modifications and improvements are possible.

The various messages described in the embodiment, Modified Examples 1 through 5, may be RRC messages or MAC CE messages. If the terminal 100 need not be in a connected state, the various messages may be broadcast messages.

In addition, the block diagram (FIG. 2) used for the explanation of the above embodiment shows a block of functional units. Those functional blocks (structural components) can be realized by a desired combination of at least one of hardware and software. Means for realizing each functional block is not particularly limited. That is, each functional block may be realized by one device combined physically or logically. Alternatively, two or more devices separated physically or logically may be directly or indirectly connected (for example, wired, or wireless) to each other, and each functional block may be realized by these plural devices. The functional blocks may be realized by combining software with the one device or the plural devices mentioned above.

Functions include judging, deciding, determining, calculating, computing, processing, deriving, investigating, searching, confirming, receiving, transmitting, outputting, accessing, resolving, selecting, choosing, establishing, comparing, assuming, expecting, considering, broadcasting, notifying, communicating, forwarding, configuring, reconfiguring, allocating (mapping), assigning, and the like. However, the functions are not limited thereto. For example, the functional block (component) that makes transmission work is called a transmitting unit (transmission unit) or transmitter. In either case, as described above, the implementation method is not particularly limited.

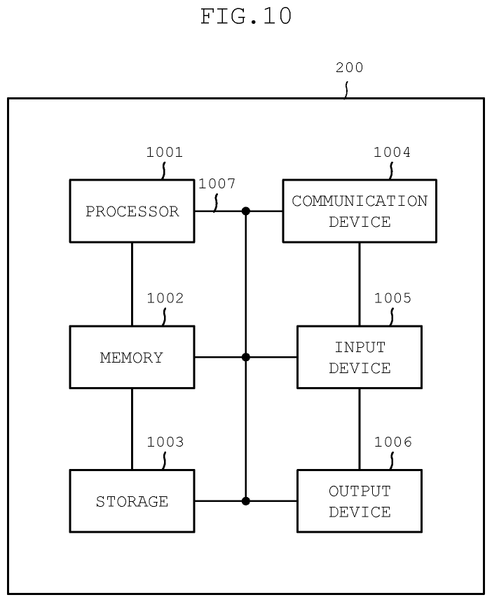

In addition, the aforementioned UE 200 (the device) may function as a computer that performs processing of the radio communication method of this disclosure. FIG. 10 shows an example of the hardware configuration of the device. As shown in FIG. 10, the device may be configured as a computer device including a processor 1001, a memory 1002, a storage 1003, a communication device 1004, an input device 1005, an output device 1006 and a bus 1007, etc.

Furthermore, in the following explanation, the term “device” can be replaced with a circuit, device, unit, and the like. Hardware configuration of the device can be constituted by including one or plurality of the devices shown in the figure, or can be constituted by without including a part of the devices.

Each functional block of the device (see FIG. 2) is realized by any hardware element of the computer device or a combination of the hardware elements.

Moreover, the processor 1001 performs computing by loading a predetermined software (computer program) on hardware such as the processor 1001 and the memory 1002, and realizes various functions of the reference device by controlling communication via the communication device 1004, and controlling reading and/or writing of data on the memory 1002 and the storage 1003.

The processor 1001, for example, operates an operating system to control the entire computer. The processor 1001 may consist of a central processing unit (CPU) including interfaces to peripheral devices, controllers, arithmetic units, registers, etc.

Moreover, the processor 1001 reads a computer program (program code), a software module, data, and the like from the storage 1003 and/or the communication device 1004 into the memory 1002, and executes various processes according to the data. As the computer program, a computer program that is capable of executing on the computer at least a part of the operation explained in the above embodiments is used. Alternatively, various processes explained above can be executed by one processor 1001 or can be executed simultaneously or sequentially by two or more processors 1001. The processor 1001 can be implemented by using one or more chips. Alternatively, the computer program can be transmitted from a network via a telecommunication line.

The memory 1002 is a computer readable recording medium and is configured, for example, with at least one of Read Only Memory (ROM), Erasable Programmable ROM (EPROM), Electrically Erasable Programmable ROM (EEPROM), Random Access Memory (RAM), and the like. Memory 1002 may be referred to as a register, cache, main memory, etc. The memory 1002 can store programs (program code), software modules, etc., that can execute a method according to one embodiment of this disclosure.

The storage 1003 is a computer readable recording medium. Examples of the storage 1003 include an optical disk such as Compact Disc ROM (CD-ROM), a hard disk drive, a flexible disk, a magneto-optical disk (for example, a compact disk, a digital versatile disk, Blu-ray (Registered Trademark) disk), a smart card, a flash memory (for example, a card, a stick, a key drive), a floppy (Registered Trademark) disk, a magnetic strip, and the like. The storage 1003 can be called an auxiliary storage device. The recording medium can be, for example, a database including the memory 1002 and/or the storage 1003, a server, or other appropriate medium.

The communication device 1004 is hardware (transmission/reception device) capable of performing communication between computers via a wired and/or wireless network. The communication device 1004 is also called, for example, a network device, a network controller, a network card, a communication module, and the like.

The communication device 1004 includes a high-frequency switch, a duplexer, a filter, a frequency synthesizer, and the like in order to realize, for example, at least one of Frequency Division Duplex (FDD) and Time Division Duplex (TDD).

The input device 1005 is an input device (for example, a keyboard, a mouse, a microphone, a switch, a button, a sensor, and the like) that accepts input from the outside. The output device 1006 is an output device (for example, a display, a speaker, an LED lamp, and the like) that outputs data to the outside. Note that, the input device 1005 and the output device 1006 may be integrated (for example, a touch screen).

Each device such as a processor 1001 and a memory 1002 is connected by a bus 1007 for communicating information. Bus 1007 may be configured using a single bus or different buses between devices.

Further, the device is configured to include hardware such as a microprocessor, a digital signal processor (Digital Signal Processor: DSP), Application Specific Integrated Circuit (ASIC), Programmable Logic Device (PLD), and Field Programmable Gate Array (FPGA). Some or all of these functional blocks may be realized by the hardware. For example, the processor 1001 may be implemented by using at least one of these hardware.

In addition, notification of information is not limited to the mode/embodiment described in this disclosure and may be made using other methods. For example, notification of information may be performed by physical layer signaling (e.g., Downlink Control Information (DCI), Uplink Control Information (UCI), higher layer signaling (e.g., RRC signaling, Medium Access Control (MAC) signaling, notification information (Master Information Block (MIB), System Information Block (SIB)), other signals or a combination thereof. The RRC signaling may also be referred to as an RRC message, for example, an RRC Connection Setup message, an RRC Connection Reconfiguration message, etc.

Each of the above aspects/embodiments can be applied to at least one of Long Term Evolution (LTE), LTE-Advanced (LTE-A), SUPER 3G, IMT-Advanced, 4th generation mobile communication system (4G), 5th generation mobile communication system (5G), Future Radio Access (FRA), New Radio (NR), W-CDMA (Registered Trademark), GSM (Registered Trademark), CDMA2000, Ultra Mobile Broadband (UMB), IEEE 802.11 (Wi-Fi (Registered Trademark)), IEEE 802.16 (WiMAX (Registered Trademark)), IEEE 802.20, Ultra-WideBand (UWB), Bluetooth (Registered Trademark), a system using any other appropriate system, and a next-generation system that is expanded based on these. Further, a plurality of systems may be combined (for example, a combination of at least one of the LTE and the LTE-A with the 5G).

The processing procedures, sequences, flowcharts, etc., of each mode/embodiment described in this disclosure may be reordered as long as there is no conflict. For example, the method described in this disclosure uses an illustrative sequence to present elements of various steps and is not limited to the specific sequence presented.

The specific operation that is performed by the base station in the present disclosure may be performed by its upper node in some cases. In a network constituted by one or more network nodes having a base station, the various operations performed for communication with the terminal may be performed by at least one of the base station and other network nodes other than the base station (for example, MME, S-GW, and the like may be considered, but not limited thereto). In the above, an example in which there is one network node other than the base station is explained; however, a combination of a plurality of other network nodes (for example, MME and S-GW) may be used.

Information, signals (information and the like) can be output from an upper layer (or lower layer) to a lower layer (or upper layer). It may be input and output via a plurality of network nodes.

The input/output information can be stored in a specific location (for example, a memory) or can be managed in a management table. The information to be input/output can be overwritten, updated, or added. The information can be deleted after outputting. The inputted information can be transmitted to another device.

The determination may be made by a value (0 or 1) represented by one bit or by Boolean value (Boolean: true or false), or by comparison of numerical values (for example, comparison with a predetermined value).

Each aspect/embodiment described in this disclosure may be used alone, in combination, or switched over as practice progresses. In addition, notification of predetermined information (for example, notification of “being X”) is not limited to being performed explicitly, it may be performed implicitly (for example, without notifying the predetermined information).

Instead of being referred to as software, firmware, middleware, microcode, hardware description language, or some other name, software should be interpreted broadly to mean instruction, instruction set, code, code segment, program code, program, subprogram, software module, application, software application, software package, routine, subroutine, object, executable file, execution thread, procedure, function, and the like.

Further, software, instruction, information, and the like may be transmitted and received via a transmission medium. For example, when a software is transmitted from a website, a server, or some other remote source by using at least one of a wired technology (coaxial cable, fiber optic cable, twisted pair, Digital Subscriber Line (DSL), or the like) and a wireless technology (infrared light, microwave, or the like), then at least one of these wired and wireless technologies is included within the definition of the transmission medium.

Information, signals, or the like mentioned above may be represented by using any of a variety of different technologies. For example, data, instruction, command, information, signal, bit, symbol, chip, or the like that may be mentioned throughout the above description may be represented by voltage, current, electromagnetic wave, magnetic field or magnetic particle, optical field or photons, or a desired combination thereof.

It should be noted that the terms described in this disclosure and terms necessary for understanding the present disclosure may be replaced by terms having the same or similar meanings. For example, at least one of the channels and symbols may be a signal (signaling). The signal may also be a message. Also, a signal may be a message. Further, a component carrier (Component Carrier: CC) may be referred to as a carrier frequency, a cell, a frequency carrier, or the like.

The terms “system” and “network” used in the present disclosure can be used interchangeably.

Furthermore, the information, the parameter, and the like explained in the present disclosure can be represented by an absolute value, can be expressed as a relative value from a predetermined value, or can be represented by corresponding other information. For example, the radio resource can be indicated by an index.

The name used for the above parameter is not a restrictive name in any respect. In addition, formulas and the like using these parameters may be different from those explicitly disclosed in the present disclosure. Because the various channels (for example, PUCCH, PDCCH, or the like) and information element can be identified by any suitable name, the various names assigned to these various channels and information elements shall not be restricted in any way.

In the present disclosure, it is assumed that “base station (Base Station: BS),” “radio base station,” “fixed station,” “NodeB,” “eNodeB (eNB),” “gNodeB (gNB),” “access point,” “transmission point,” “reception point,” “transmission/reception point,” “cell,” “sector,” “cell group,” “carrier,” “component carrier,” and the like can be used interchangeably. The base station may also be referred to with the terms such as a macro cell, a small cell, a femtocell, or a pico cell.

The base station can accommodate one or more (for example, three) cells (also called sectors). In a configuration in which the base station accommodates a plurality of cells, the entire coverage area of the base station can be divided into a plurality of smaller areas. In each such a smaller area, communication service can be provided by a base station subsystem (for example, a small base station for indoor use (Remote Radio Head: RRH)).

The term “cell” or “sector” refers to a part or all of the coverage area of a base station and/or a base station subsystem that performs communication service in this coverage.

In the present disclosure, the terms “mobile station (Mobile Station: MS),” “user terminal,” “user equipment (User Equipment: UE),” “terminal” and the like can be used interchangeably.

The mobile station is called by the persons skilled in the art as a subscriber station, a mobile unit, a subscriber unit, a radio unit, a remote unit, a mobile device, a radio device, a radio communication device, a remote device, a mobile subscriber station, an access terminal, a mobile terminal, a radio terminal, a remote terminal, a handset, a user agent, a mobile client, a client, or with some other suitable term.

At least one of a base station and a mobile station may be called a transmitting device, a receiving device, a communication device, or the like. Note that, at least one of a base station and a mobile station may be a device mounted on a moving body, a moving body itself, or the like. The mobile body may be a vehicle (For example, cars, airplanes, etc.), an unmanned mobile body (For example, drones, self-driving cars, etc.) or a robot (manned or unmanned). At least one of a base station and a mobile station can be a device that does not necessarily move during the communication operation. For example, at least one of a base station and a mobile station may be an Internet of Things (IoT) device such as a sensor.

In addition, base stations in this disclosure may be read as mobile stations (user terminal, hereinafter the same). For example, each aspect/embodiment of this disclosure may be applied to a configuration in which communication between a base station and a mobile station is replaced by communication between multiple mobile stations (For example, it may be called Device-to-Device (D2D), Vehicle-to-Everything (V2X), etc.). In this case, the mobile station may have the function of the base station. In addition, phrases such as “up” and “down” may be replaced with phrases corresponding to communication between terminals (For example, “side”). For example, terms an uplink channel, a downlink channel, or the like may be read as a side channel.

Similarly, mobile stations in this disclosure may be read as base stations. In this case, the base station may have the function of the mobile station. A radio frame may be composed of one or more frames in the time domain. Each frame or frames in the time domain may be referred to as a subframe. A subframe may be further configured by one or more slots in the time domain. The subframe may have a fixed length of time (For example, 1 ms) independent of numerology.

Numerology may be a communication parameter applied to at least one of transmission and reception of a certain signal or channel. The numerology can include one among, for example, subcarrier spacing (SubCarrier Spacing: SCS), bandwidth, symbol length, cyclic prefix length, transmission time interval (Transmission Time Interval: TTI), number of symbols per TTI, radio frame configuration, a specific filtering process performed by a transceiver in the frequency domain, a specific windowing process performed by a transceiver in the time domain, and the like.

The slot may be configured with one or a plurality of symbols (Orthogonal Frequency Division Multiplexing (OFDM)) symbols, Single Carrier Frequency Division Multiple Access (SC-FDMA) symbols, etc.) in the time domain. A slot may be a unit of time based on the numerology.

A slot may include a plurality of minislots. Each minislot may be configured with one or more symbols in the time domain. A minislot may also be called a subslot. A minislot may be composed of fewer symbols than slots. A PDSCH (or PUSCH) transmitted in units of time larger than a minislot may be called a PDSCH (or PUSCH) mapping type A. PDSCH (or PUSCH) transmitted using a minislot may be referred to as PDSCH (or PUSCH) mapping type B.

Each of the radio frame, subframe, slot, minislot, and symbol represents a time unit for transmitting a signal. Different names may be used for the radio frame, subframe, slot, minislot, and symbol.

For example, one subframe may be called a transmission time interval (TTI), a plurality of consecutive subframes may be called TTI, and one slot or one minislot may be called TTI. That is, at least one of the subframes and TTI may be a subframe (1 ms) in an existing LTE, may have a duration shorter than 1 ms (For example, 1-13 symbols), or may have a duration longer than 1 ms. Note that, a unit representing TTI may be called a slot, a minislot, or the like instead of a subframe.

Here, TTI refers to the minimum time unit of scheduling in radio communication, for example. Here, TTI refers to the minimum time unit of scheduling in radio communication, for example. For example, in the LTE system, the base station performs scheduling for allocating radio resources (frequency bandwidth, transmission power, etc. that can be used in each user terminal) to each user terminal in units of TTI. The definition of TTI is not limited to this.

The TTI may be a transmission time unit such as a channel-encoded data packet (transport block), a code block, or a code word, or may be a processing unit such as scheduling or link adaptation. When TTI is given, a time interval (for example, the number of symbols) in which a transport block, a code block, a code word, etc. are actually mapped may be shorter than TTI.

When one slot or one minislot is called TTI, one or more TTIs (that is, one or more slots or one or more minislots) may be the minimum scheduling unit. In addition, the number of slots (number of minislots) constituting the minimum time unit of the scheduling may be controlled.

TTI having a time length of 1 ms may be referred to as an ordinary TTI (TTI in LTE Rel. 8-12), a normal TTI, a long TTI, a normal subframe, a normal subframe, a long subframe, a slot, and the like. TTI shorter than the ordinary TTI may be referred to as a shortened TTI, a short TTI, a partial TTI (partial or fractional TTI), a shortened subframe, a short subframe, a minislot, a subslot, a slot, and the like.

In addition, a long TTI (for example, ordinary TTI, subframe, etc.) may be read as TTI having a time length exceeding 1 ms, and a short TTI (for example, shortened TTI) may be read as TTI having TTI length of less than the TTI length of the long TTI but TTI length of 1 ms or more.

The resource block (RB) is a resource allocation unit in the time domain and frequency domain, and may include one or a plurality of continuous subcarriers in the frequency domain. The number of subcarriers included in RB may be, for example, twelve, and the same regardless of the topology. The number of subcarriers included in the RB may be determined based on the neurology.

Also, the time domain of RB may include one or a plurality of symbols, and may have a length of 1 slot, 1 minislot, 1 subframe, or 1 TTI. Each TTI, subframe, etc. may be composed of one or more resource blocks.

Note that, one or more RBs may be called a physical resource block (Physical RB: PRB), a subcarrier group (Sub-Carrier Group: SCG), a resource element group (Resource Element Group: REG), PRB pair, RB pair, etc.

A resource block may be configured by one or a plurality of resource elements (Resource Element: RE). For example, one RE may be a radio resource area of one subcarrier and one symbol.

A bandwidth part (BWP) (which may be called a partial bandwidth, etc.) may represent a subset of contiguous common resource blocks (RBs) for a certain neurology in a certain carrier. Here, the common RB may be identified by an index of RBs relative to the common reference point of the carrier. PRB may be defined in BWP and numbered within that BWP.

BWP may include UL BWP (UL BWP) and DL BWP (DL BWP). One or a plurality of BWPs may be set in one carrier for the UE.

At least one of the configured BWPs may be active, and the UE may not expect to send and receive certain signals/channels outside the active BWP. Note that “cell,” “carrier,” and the like in this disclosure may be read as “BWP.”

The above-described structures such as a radio frame, subframe, slot, minislot, and symbol are merely examples. For example, the number of subframes included in a radio frame, the number of slots per subframe or radio frame, the number of minislots included in a slot, the number of symbols and RBs included in a slot or minislot, the subcarriers included in RBs, and the number of symbols included in TTI, a symbol length, the cyclic prefix (CP) length, and the like can be changed in various manner.

The terms “connected,” “coupled,” or any variations thereof, mean any direct or indirect connection or coupling between two or more elements. Also, one or more intermediate elements may be present between two elements that are “connected” or “coupled” to each other. The coupling or connection between the elements may be physical, logical, or a combination thereof. For example, “connection” may be read as “access.” In the present disclosure, two elements can be “connected” or “coupled” to each other by using one or more wires, cables, printed electrical connections, and as some non-limiting and non-exhaustive examples, by using electromagnetic energy having wavelengths in the microwave region and light (both visible and invisible) regions, and the like.

The reference signal may be abbreviated as Reference Signal (RS) and may be called pilot (Pilot) according to applicable standards.

As used in the present disclosure, the phrase “based on” does not mean “based only on” unless explicitly stated otherwise. In other words, the phrase “based on” means both “based only on” and “based at least on.”

The “means” in the configuration of each apparatus may be replaced with “unit,” “circuit,” “device,” and the like.

Any reference to an element using a designation such as “first,” “second,” and the like used in the present disclosure generally does not limit the amount or order of those elements. Such designations can be used in the present disclosure as a convenient way to distinguish between two or more elements. Thus, the reference to the first and second elements does not imply that only two elements can be adopted, or that the first element must precede the second element in some or the other manner.

In the present disclosure, the used terms “include,” “including,” and variants thereof are intended to be inclusive in a manner similar to the term “comprising.” Furthermore, the term “or” used in the present disclosure is intended not to be an exclusive disjunction.

Throughout this disclosure, for example, during translation, if articles such as a, an, and the in English are added, in this disclosure, these articles shall include plurality of nouns following these articles.

As used in this disclosure, the terms “determining” and “determining” may encompass a wide variety of actions. “Judgment” and “decision” includes judging or deciding by, for example, judging, calculating, computing, processing, deriving, investigating, looking up, search, inquiry (e.g., searching in a table, database, or other data structure), ascertaining, and the like. In addition, “judgment” and “decision” can include judging or deciding by receiving (for example, receiving information), transmitting (for example, transmitting information), input (input), output (output), and access (accessing) (e.g., accessing data in a memory). In addition, “judgement” and “decision” can include judging or deciding by resolving, selecting, choosing, establishing, and comparing. That is, “judgment” and “determination” may include regarding some action as “judgment” and “determination.” Moreover, “judgment (decision)” may be read as “assuming,” “expecting,” “considering,” and the like.

In the present disclosure, the term “A and B are different” may mean “A and B are different from each other.” It should be noted that the term may mean “A and B are each different from C.” Terms such as “leave,” “coupled,” or the like may also be interpreted in the same manner as “different.”

Although the present disclosure has been described in detail above, it will be obvious to those skilled in the art that the present disclosure is not limited to the embodiments described in this disclosure. The present disclosure can be implemented as modifications and variations without departing from the spirit and scope of the present disclosure as defined by the claims. Therefore, the description of the present disclosure is for the purpose of illustration, and does not have any restrictive meaning to the present disclosure.

### EXPLANATION OF REFERENCE NUMERALS

10 control system
20 TSN GM
30 NR system
31 NR GM
40 TSN end station
100 terminal
101 radio transmission unit
103 radio reception unit
105 time processing unit
107 message processing unit
109 control unit
200 NG-RAN
210 gNB
300 core network
310 UPF
1001 processor
1002 memory
1003 storage
1004 communication device
1005 input Device
1006 output Device
1007 bus

1. A terminal comprising:
a control unit that performs processing related to a first network and a second network; and
a transmission unit that transmits a message used in the first network and including time information of the second network, when two or more terminals, to which two or more stations belongs to the second network respectively connected, are located in a neighborhood.

2. The terminal according to claim 1, wherein the transmission unit transmits a radio resource connection message used in the first network to the first network as the message.

3. The terminal according to claim 1, wherein the transmission unit transmits, as the message, a sidelink message used between terminals that can be connected to the first network to another terminal.

4. A terminal comprising:
a reception unit that receives a message including timing information used to adjust a timing of an uplink signal; and
a control unit that performs a propagation delay compensation based on the timing information when a predetermined condition is satisfied.

5. The terminal of claim 4, wherein the predetermined condition includes at least any one of a condition in which the propagation delay time specified by the timing information is greater than a predetermined threshold value and a condition in which an instruction regarding an execution of the propagation delay compensation is existed.

6. The terminal according to claim 2, wherein the transmission unit transmits, as the message, a sidelink message used between terminals that can be connected to the first network to another terminal.
